(19) United States
(12) Patent Application Publication
(10) Pub. No.: US 2018/0207665 A1
(43) Pub. Date: Jul. 26, 2018

(54) Spring loaded irrigation riser

(71) Applicant: Mark Francis Plummer, Burbank, WA (US)

(72) Inventor: Mark Francis Plummer, Burbank, WA (US)

(21) Appl. No.: 15/384,784

(22) Filed: Jan. 23, 2017

(51) Int. Cl. B05B 15/08; B05B 15/04; B05B 15/10

(52) U.S. Cl. CPC B05B 15/08; B05B 1/30; B05B 15/10; B05B 15/0456

(57) ABSTRACT

This invention is to reduce the number of irrigation risers needing replacement throughout the pasture irrigation season due to livestock interaction causing breaking of the riser.

### BRIEF DESCRIPTION

The SPRING LOADED IRRIGATION RISER is made up of a flexible water supply pipe surrounded by a spring.

### BRIEF DESCRIPTION OF DRAWINGS

FIG. 1 the SPRING LOADED IRRIGATION RISER is to be used in a pasture area where grazing livestock tend to brake off a typical rigid riser. The spring mechanism (drawing detail 3) in conjunction with the flexible PVC piping (drawing detail 2) will permit the riser to be moved from side to side and return to the vertical operational position. The SPRING LOADED IRRIGATION RISER can be placed by either gluing or threaded couplings (drawing detail 1) onto the terminal end of an irrigation water line. The invention is the application of the spring surrounding a flexible water pipe with an anchoring device (deadman) permitting the movement of the riser without breaking (drawing detail 4).

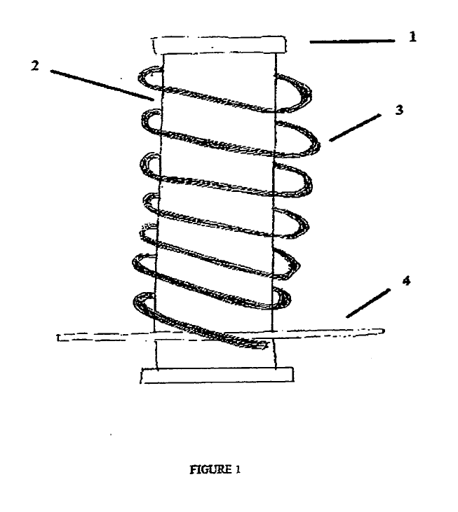

1. A component of an water irrigation system used in the agricultural, farming or other irrigation systems where it is necessary to permit the irrigation riser to be flexible when lateral pressure is put on it.

2. The irrigation pipe contained in the spring is flexible.

3. The spring surrounding the flexile irrigation pipe is such as to permit it to bend when a force is applied but remain ridged to permit the use of impact style water sprinklers or non impact style water sprinklers.
